(19) United States
(12) Patent Application Publication
(10) Pub. No.: US 2008/0222957 A1
(43) Pub. Date: Sep. 18, 2008

(54) Door Drive Mechanism, Especially Revolving Door Drive Mechanism

(75) Inventor: Volker Bienek, Dortmund (DE)

Correspondence Address: COHEN, PONTANI, LIEBERMAN & PAVANE LLP, 551 FIFTH AVENUE, SUITE 1210, NEW YORK, NY, 10176, US

(73) Assignee: DORMA GMBH + CO. KG, Ennepetal (DE)

(21) Appl. No.: 11/793,206

(22) PCT Filed: Nov. 14, 2005
(86) PCT No.: PCT/EP05/12164

§ 371 Date: Jun. 18, 2007

(30) Foreign Application Priority Data
Dec. 17, 2004 (DE) 10 2004 061 626.4

(51) Int. Cl. E05D 15/02; E05F 3/22

(52) U.S. Cl. 49/43

(57) ABSTRACT

A door operator includes a housing; a hydraulic compartment providing a reservoir volume; a sealed pressure compartment; a drive unit disposed in the housing and coupleable to a door via an output shaft; a hydraulic pump in hydraulic connection with the hydraulic compartment and the sealed pressure compartment; a motor in driving relationship with the hydraulic pump; and a spring force accumulator disposed in the housing. The spring force accumulator is associated with the sealed pressure compartment and coupled to the drive unit.

The invention relates to a door operator, in particular to a swing door operator according to the generic part of patent claim 1.

Such a door operator is known from DE 295 21 068 U1. An overhead door closer with a slide rail linkage is known from DE 40 38 720 C2, which has a cam drive unit allowing for an optimum door moment curve and a comfortable operation. In principle this overhead door closer would therefore be suitable as door operator as well; however, experiments conducted during the course of the invention have shown that applying oil pressure to the drive unit results in a very unfavourable transformation of the hydraulic pressure in the resulting movement of stroke/rotation and repeated stroke. Since about 75% of the output capacity to be applied is required for loading the spring force accumulator of such a door closer, whereas only about 25% of the output capacity needs to be delivered by the system for accelerating the door. As it is furthermore desirable to keep the narrow structural shape of such a door closer for door operators as well, the dimensions of the structural components cannot be adapted to the extremely high loads. Thus, although functionally and technically advantageous, the known overhead door closer is not suitable as a door operator.

Another swing door operator is known from DE 197 56 496 C2. This swing door operator has an electromechanical drive unit, which is provided with a drive motor and a gear and with a subsequent power transmission unit for the connected door. The power transmission unit has a spindle with a spindle nut partially overlapping the former, which spindle is non-positively and positively connected to a toothed rack. Although this swing door operator can be installed concealed, the door moment curve is not as optimal as with the above described door closers having the cam technology.

Therefore, it is the object of the present invention to provide a door operator of the species indicated in the generic part of patent claim 1, which can be installed completely concealed within the door profile or frame profile, and does not require any special constructions of the door system.

This problem is solved by the features of patent claim 1.

On account of its compact structure, the inventive door operator allows for a concealed installation within a door profile or a frame profile and thus allows for total integration with the door system.

Particularly the installation in common narrow door profiles is possible.

As an advantage, neither special door profiles nor any special constructions, which would interfere with the design of the door system, are necessary. Another advantage results from an economical mounting combined with a wide applicability and moreover, it is possible to retrofit existing door systems with the inventive door operator. Another advantage results from the fact that, with the inventive door operator, a direct introduction of power for loading a spring force accumulator is possible. Thus the possibility is given of avoiding unnecessarily loading the mechanical structural components, and a reduction of the required operating pressure can be achieved, because larger effective piston areas are provided. As the hydraulic pump of the inventive door operator is in hydraulic connection with a separate pressure compartment, which is associated directly to the spring force accumulator, a direct pressure application and thus a direct introduction of power into the spring force accumulator is the result, whereby the pre-loading of the spring force accumulator is completely or at least partially achieved. By this measure the disadvantages explained at the beginning are completely eliminated, because unnecessary losses are avoided.

The inventive door operator further achieves avoiding unnecessary stress on structural components, load on bearings, and any loss on account of friction or loss of efficiency. On account of a separate pressure compartment associated to the spring force accumulator, the effective piston areas for loading the spring force accumulator and thus for generating a higher driving torque are further increased and, moreover, the required system pressure is thus considerably reduced and the stroke volume is increased. As a consequence, the control response is improved and the overall hydraulic system is less sensitive, whereby a more precise control of the door operator can be realized.

It can thus be achieved that the torque required at the output shaft for opening the doors can be generated by means of a cam arrangement, while the spring loading work is simultaneously generated in the separate pressure compartment.

Through providing the pressure compartment, associated to the spring force accumulator, and a preferably provided specific hydraulic control, such as through the use of a solenoid valve, further hydraulic functions such as hydraulic hold-open or hydraulic closing sequence control are made possible.

Furthermore, it is possible to realize a hydraulic opening damping and to use differently built drive units.

Advantageous further developments of the invention are the subject matter of the dependent claims.

Further details, features and advantages of the invention will become apparent from the following description of exemplary embodiments, reference being made to the drawings, in which:

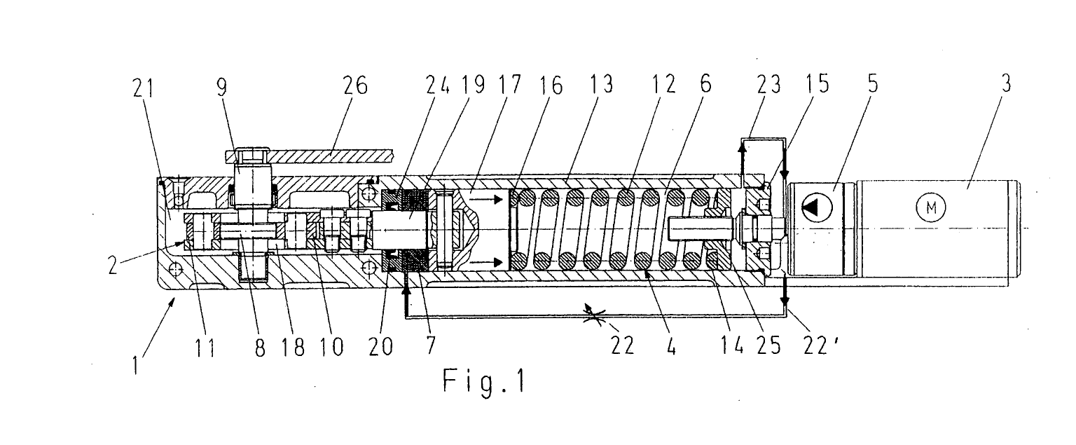

FIG. 1 shows a diagrammatically slightly simplified basic illustration of an embodiment of an inventive door operator; and

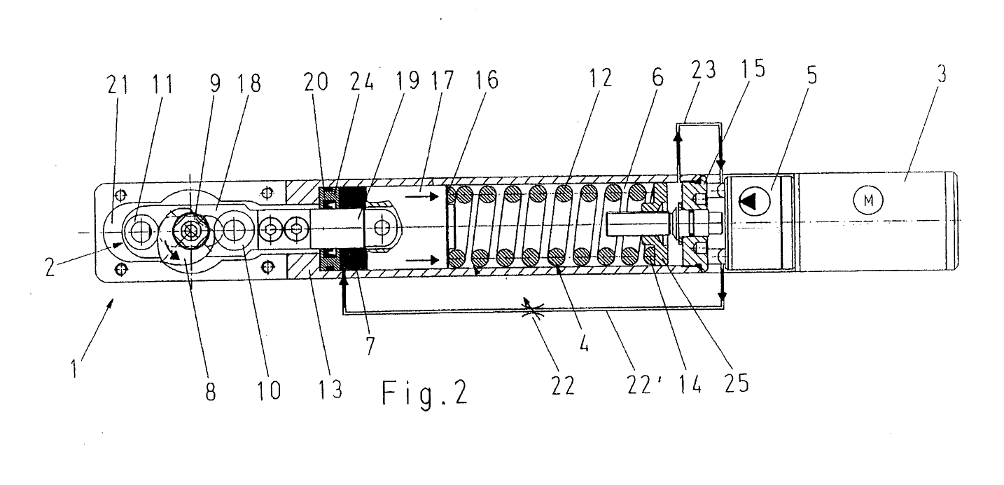

FIG. 2 shows a top view on the door operator according to FIG. 1.

FIG. 1 shows an inventive door operator 1, which in particular can be executed as a swing door operator. The door operator 1 has a drive unit 2, which, via an output shaft 9, can be coupled to a door not illustrated in FIG. 1, for example via a lever 26 and a slide channel with a sliding member. The drive unit 2 is disposed in a housing 13.

Furthermore, the door operator 1 has a motor 3, as well as a spring force accumulator 4 disposed in the housing 13, which accumulator is coupled to the motor 3 and to the drive unit 2.

As revealed in FIGS. 1 and 2, the motor 3 is in driving connection with a hydraulic pump 5. In the illustrated embodiment, the motor 3 and the hydraulic pump 5 are disposed at the housing 13; however, they might be distinctly flange-mounted to or integral with the housing 13. The motor 3, via the hydraulic pump 5 and a first hydraulic line 22′, is in hydraulic connection with a pressure compartment 7, which is associated to the spring force accumulator 4. The first hydraulic line 22′ may be provided with a throttle 22. Via a second hydraulic line 23, the motor 3 and the pump 5 are in hydraulic connection with a hydraulic compartment 6, wherein a compression spring 12 is disposed, and which compartment serves as a reservoir volume.

In the embodiment illustrated in FIGS. 1 and 2, the drive unit 2 is formed as a cam drive. This cam drive has a cam disc 8, which is disposed on the output shaft 9. The cam disc 8 cooperates with two force transmission rollers 10 and 11, which are disposed on both sides of the output shaft 9 on a cam plate assembly 18 and bear on different cam paths of the cam disc 8. Through rotating the output shaft 9, the compression spring 12 is loaded, because the cam plate assembly 18, via a piston rod 19, passes through an internal compartment of a separating wall 24 and is attached to a spring loading piston 17. As the force transmission rollers, which, in this embodiment, are aligned towards the centre of the axis of the door operator 1, are secured to the cam plate assembly 18, the distance between them remains constant.

As revealed in FIG. 1, a spring loading piston 17, which directly introduces the power for loading the compression spring 12 into the latter, is disposed in the pressure compartment 7. The spring loading piston 17 is connected to the cam plate assembly 18 via a piston rod 19, whereby, when applying pressure in the pressure compartment 7, a subsequent introduction of power into the piston rod 19 is also realized, which is guided into a reception compartment 21 passing through a joint 20. The joint 20 is disposed in a separating wall 24 between the pressure compartment 7 and the reception compartment 21.

FIG. 1 shows furthermore that in the exemplary embodiment, one end 14 of the spring 12, via a spring force adjusting device 25, bears indirectly against a housing wall 15 of the housing 13, whereas the other end 16 thereof bears against the spring loading piston 17.

As revealed in FIGS. 1 and 2, the result is the extremely compact design explained at the beginning, which allows for a completely concealed installation in door profiles or frame profiles.

### LIST OF REFERENCES

1 door operator
2 drive unit
3 motor
4 spring force accumulator
5 hydraulic pump
6 hydraulic compartment
7 pressure compartment
8 cam disc
9 output shaft
10 force transmission rollers
11 force transmission rollers
12 compression spring
13 housing
14 end
15 housing wall
16 end
17 spring loading piston
18 cam plate assembly
19 piston rod
20 joint
21 reception compartment
22 throttle
22′ first hydraulic line
23 second hydraulic line
24 separating wall
25 spring force adjusting device
26 lever

1.-8. (canceled)

9. A door operator comprising:
a housing defining a hydraulic compartment providing a reservoir volume;
a drive unit disposed in the housing and having an output shaft coupleable to a door;
a hydraulic pump in hydraulic connection with the hydraulic compartment and a sealed pressure compartment;
a motor in driving connection with the hydraulic pump; and
a spring force accumulator disposed in the housing, the spring force accumulator being associated with the sealed pressure compartment and coupled to the drive unit, the motor being coupled with the spring force accumulator.

10. The door operator of claim 9, wherein the drive unit comprises a cam drive comprising a cam disc mounted on the output shaft and first and second force transmission rollers disposed on two sides of the output shaft and bearing on cam paths of the cam disc.

11. The door operator of claim 10, wherein the spring force accumulator comprises a spring loading piston and a compression spring, the compression spring having a first end bearing against one of a wall of the housing and a spring force adjusting device disposed in the housing, and a second end bearing against the spring loading piston.

12. The door operator of claim 11, wherein the housing has a reception compartment for accommodating the drive unit and a separating wall, the sealed pressure compartment being disposed adjacent to the spring loading piston and sealed relative to the reception compartment by the separating wall.

13. The door operator of claim 12, further comprising a piston rod and a cam plate assembly which is connected to the spring loading piston via the piston rod, the first and second force transmission rollers being mounted on the cam plate assembly.

14. The door operator of claim 13, further comprising a seal disposed in the separating wall, the piston rod extending through the seal.

15. The door operator of claim 9, further comprising a hydraulic line connecting the hydraulic pump with the sealed pressure compartment, and a throttle disposed in the hydraulic line.

16. The door operator of claim 9, wherein the motor comprises one of an alternating current micro-motor and a direct current micro-motor.

17. The door operator of claim 9, wherein the door operator is a swing door operator.
